(19) United States
(12) Patent Application Publication
(10) Pub. No.: US 2008/0101053 A1
(43) Pub. Date: May 1, 2008

(54) Multiplexed image displaying wheel assembly

(76) Inventors: Jon Hoffman, Malibu, CA (US); Bryan Dangott, Phoenix, AZ (US)

Correspondence Address: CHRISTIE, PARKER & HALE, LLP, PO BOX 7068, PASADENA, CA, 91109-7068, US

(21) Appl. No.: 11/784,850

(22) Filed: Apr. 9, 2007

Related U.S. Application Data
(60) Provisional application No. 60/854,921, filed on Oct. 27, 2006.

(51) Int. Cl. B60B 7/04; G09F 21/04; G09G 3/04

(52) U.S. Cl. 362/35; 310/232; 324/207.2; 345/33; 345/82; 40/587

(57) ABSTRACT

A method and apparatus for displaying an image on a rotatable wheel. A computer processing system is mounted on an inward face of an overcap mountable on the rotatable wheel. Light emitters are mounted on an outward face of the overcap, the light emitters responsive to light emission signals from the computer central processing system. A slip ring assembly is axially mounted on an inward face of the rotatable wheel, the slip ring assembly adapted to provide electrical power to the computer processing system. A trolley assembly is fixedly mounted to a chassis such that the trolley assembly is axially aligned with the slip ring assembly, the trolley assembly adapted to couple the electrical power to the slip ring assembly. Displayable image signals are provided to the computer processing system, the computer processing system adapted to transmit the light emission signals corresponding to the image to the light emitters.

### CROSS-REFERENCE TO RELATED APPLICATION

This application claims the benefit of U.S. Provisional Patent Application No. 60,854,921 filed in the U.S. Patent and Trademark Office on Oct. 27, 2006, the entire content of which is incorporated herein by reference.

### BACKGROUND

The present invention relates to the field of visual displays, and in particular, to visual displays on a rotating wheel, such as an automotive wheel.

Automotive enthusiasts routinely wish to communicate with other drivers, including maintaining and enhancing the appearance of their vehicles. A unique or even customized wheel assembly is generally known to enhance the overall appearance of the vehicle.

### SUMMARY OF THE INVENTION

In accordance with the present invention, a method and apparatus is provided for displaying an image on a rotatable wheel, such as an automotive wheel.

In an exemplary embodiment the rotatable wheel is mountable on a hub rotatable relative to a fixed chassis. A computer processing system is mounted on an inward face of an overcap which is mountable on the rotatable wheel. Light emitters are mounted on an outward face of the overcap, the light emitters being responsive to light emission signals from the computer central processing system. A slip ring assembly is axially mounted on an inward face of the rotatable wheel, the slip ring assembly being adapted to provide electrical power to the computer processing system. A trolley assembly is fixedly mounted to the chassis such that the trolley assembly is axially aligned with the slip ring assembly, the trolley assembly being adapted to couple the electrical power to the slip ring assembly. Displayable image signals are provided to the computer processing system, the computer processing system being adapted to transmit the light emission signals corresponding to the image to the light emitters.

The displayable image signals may be sent to the computer processing system by wireless communication from a remote terminal.

The trolley assembly may include a sensor flag fixedly mounted on the trolley assembly. The slip ring assembly may include a sensor mounted on the slip ring assembly, the sensor detecting sensor flag presence as the sensor flag passes the sensor as the rotatable wheel rotates to provide wheel rotational speed information to the computer processing system. The light emission signals may be synchronizingly transmitted by the computer processing system to the light emitters to provide a fixed image corresponding to the wheel rotational speed information.

The trolley assembly may include a brush holder housing a spring-loaded carbon brush making electrical contact with a slip ring of the slip ring assembly, the slip ring being electrically coupled to the computer processing system, the spring-loaded carbon brush receiving electrical power from a remote power source and providing electrical power to the slip ring.

The light emitters may be one or more light emitting diode assemblies, each light emitting diode assembly including a series of light emitting diodes radially mounted.

The displayable image signals may be provided to the computer processing system by: converting the image into a series of pixels arranged in a matrix, a column height of the matrix corresponding to a number of light emitters arranged radially in series on the overcap, a row length of the matrix corresponding to a radial-to-linear parsing value of the image; and synchronizing the wheel rotational speed information with the matrix to provide light emitter timing information to the computer processing system.

The sensor may be a Hall Effect sensor.

The rotatable wheel may be an automotive wheel.

### BRIEF DESCRIPTION OF THE DRAWINGS

FIG. 1 shows an exemplary embodiment of the present invention on a vehicle shown in phantom.

FIG. 2 shows four exemplary embodiments of image displays in accordance with the present invention.

FIG. 3 shows a schematic depiction of an exemplary image being lit in accordance with the present invention.

FIG. 4 shows an inside face of a vehicle wheel in accordance with the present invention.

FIG. 5 shows an inside face of a vehicle wheel with a slip ring assembly with a trolley assembly mounted in accordance with the present invention.

FIG. 6 shows a trolley assembly with a Hall Effect sensor and its support structure more prominently displayed in accordance with the present invention.

FIG. 7 shows an opposite side of the trolley assembly depicted in FIG. 6.

FIG. 8 shows a ferrous flag and a Hall Effect sensor on its mounting bracket in accordance with the present invention.

FIG. 9 shows an outward facing side of an overcap in accordance with the present invention.

FIG. 10 shows an inward facing side of the overcap shown in FIG. 9.

FIG. 11 shows a further view of a trolley assembly in accordance with the present invention.

FIGS. 12, 13, 14 and 15 show exemplary circuitry in accordance with the present invention.

FIGS. 16B, 16R and 16G show exemplary shift registers for respective blue, red and green LED emission in accordance with the present invention.

FIG. 17 shows in block diagram form an exemplary user interface application flow chart in accordance with the present invention.

FIG. 18 shows exemplary wrapped text and flat line text image displays in accordance with the present invention.

FIG. 19 shows an exemplary wheel application software user interface in accordance with the present invention.

### DETAILED DESCRIPTION

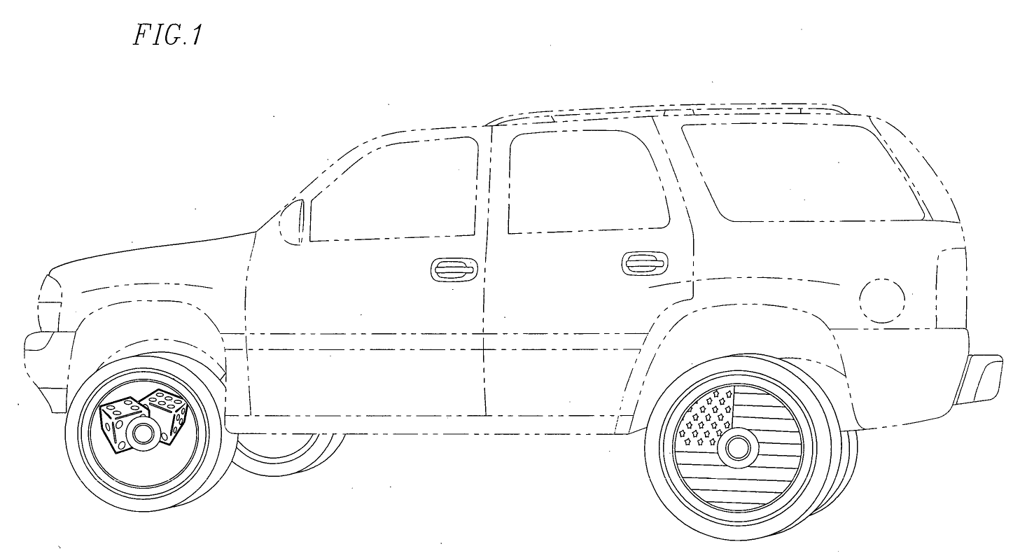

Referring to FIG. 1, an automobile is shown in phantom wherein, when moving, light emitting diodes (LEDs) mounted on the front wheel display a pair of dice while LEDs mounted on the rear wheel display an American flag.

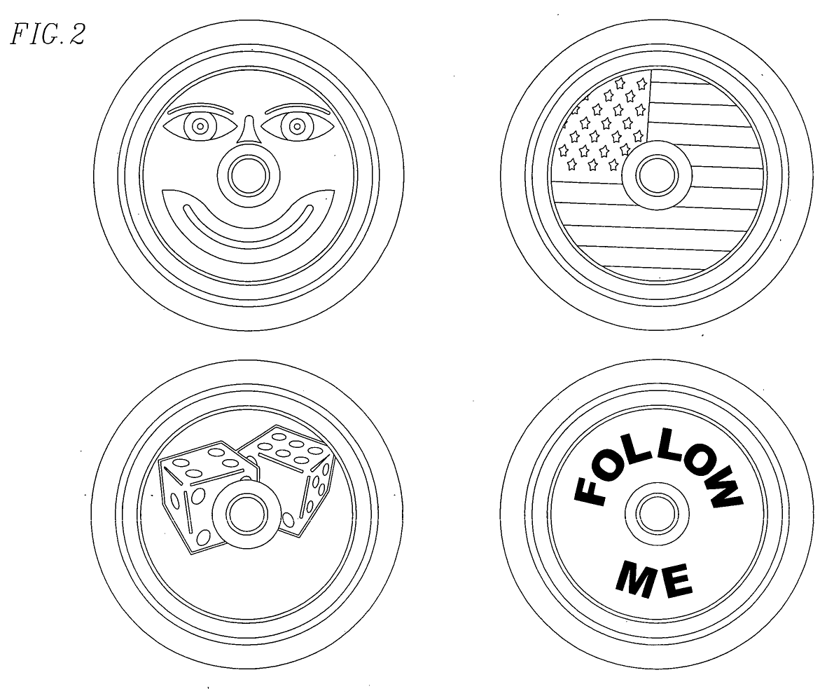

Referring to FIG. 2, there are shown four exemplary individual image displays, each of which could be selected to be displayed on a vehicle as shown in FIG. 1.

In an embodiment of the present invention a multiplicity of emissive devices, for example, tri-color LEDs, are arranged on the outward face of a standard automotive wheel (or an ‘overcap’ which mounts to the outward face) in a radial ‘spoke’ pattern emanating from the center of the wheel and continuing to the outer perimeter of the wheel. A computer central processing unit (CPU) and related circuitry selectively illuminate the emissive devices to provide a desired visual display.

Communication means are provided whereby data is transmitted to the CPU while the wheel is in motion. In an exemplary embodiment a wireless radio frequency (RF) modem is employed. However, any of a number of wireless technologies may be employed including infrared or Bluetooth. A wired approach may be employed wherein the data signal is overlaid on power lines.

Speed and position sensing hardware are incorporated in the wheel.

Means of supplying electrical power is provided. In an exemplary embodiment, power is provided by means of slip rings/brushes. In one embodiment, a single positive slip ring may be employed and ground may be routed through the wheel/axle assembly. Power may also be provided through batteries or a wheel-motion actuated generator.

While stationary, the ‘spokes’ may be illuminated in a conventional manner. For example, lights may be turned on in a certain color, may change colors, may be ‘chaser lights,’ or provide random patterns presenting patterns of visual interest.

When the wheels are rotating, the limited number of lights on the ‘spokes’ actually paint the entire face of the wheel with light, functionally multiplexing a small number of emissive devices to illuminate the entirety of the wheel surface.

The CPU is employed to selectively turn on and off the lights at precise points in their rotational trajectory such that stable images may be formed across the entire wheel surface.

The relatively small number of lights, when spinning fast enough, create cohesive images on the wheel surface. The operative cognitive principles which are being exploited in this invention are not unlike those underlying the effectiveness of motion pictures, such as persistence of vision and flicker fusion.

The manner in which images are created and displayed is as follows:

1) an image is drawn or imported into a software application.

2) the software application converts the image into a series of pixels arranged in a matrix. The column height of the matrix corresponds to the number of lights arranged lengthwise in each radial ‘spoke,’ while the row length of the matrix is an arbitrary number based on the radial ‘parsing’ of the image one wishes to employ while ‘painting’ an image. In an exemplary embodiment, the image is parsed 360 times radially.

3) as the wheel rotates, speed and position sensors constantly monitor rotational speed and rotational position of the wheel. In an exemplary embodiment Hall Effect sensors are used, but many other means could be employed.

4) the speed information is used to calculate how long it takes the wheel to rotate one degree (or one 360th of a revolution) and this data is used to determine the precise timing for sending image information to the lights.

5) the image information is sent to the lights as follows:

a) for any given rotational position of the wheel, the ‘spokes’ of lights will be in one of 360 possible rotational positions comprising the entirety of the image being generated.

b) once it is determined which of these 360 possible positions the spoke is in (this calculation is based on knowing the total time which has elapsed since the wheel hit top dead center, then dividing this total elapsed time by 1/360th of the time for a complete revolution) the resulting number corresponds to the column number of the current position.

c) the CPU interrogates the matrix and determines which column of the 360 total columns (corresponding to 360 degrees of rotation) is appropriate for the spoke's current position, and sends or ‘strobes’ the data from this column to the individual lights comprising the spoke, thereby illuminating this particular one degree sliver of the subject image. In an exemplary embodiment, three spokes per wheel arranged in a radially symmetrical 120 degree displaced pattern are employed. Three spokes are strobed simultaneously, the data being drawn concurrently from three columns of the matrix, always 120 degrees apart. For example, at top dead center, columns 0, 120, and 240 would be strobed to the three spokes. At the next one degree interval of rotation, columns 1, 121, and 241 would be strobed, and so on, until the entirety of the matrix data has been sent to the spokes over one complete revolution. This process occurs fast enough that the image, although never actually illuminated more than a fractional amount at any given time, is perceived by the viewer to be stable and monolithic.

In accordance with an exemplary embodiment of the present invention, a custom wheel system is provided. The wheel system includes an overcap (hubcap) which holds the display electronics and the CPU, power and sensing components, and a specialized wheel.

The wheel is made up of two parts: a rim or barrel (cylindrical round portion that the tire mounts on) and the wheel center.

The wheel center is based on a standard wheel casting but modified with geometries that are specific to the embodiment. The rear inward facing portion of the center has a pad which mounts on the hub of the vehicle and makes contact with the hub. The geometry of the center is such to allow it to accommodate the slip ring assembly, which is where the power comes from and where the speed and position sensing apparatus are located. There are six holes located on the pad for mounting the slip ring assembly. The pad includes at its edge a rectangular milled slot pass-through hole to allow a wire harness to pass through.

The slip ring assembly is mounted on the wheel such that a track assembly is registered and keyed by the rectangular pass-through hole using a drop down molded-in sleeve so that the mounting holes are registered and accessible from the other side. Through bolts allow it to become rigidly affixed to the wheel center. A brass slip ring is provided. A trolley plate is secured to the slip ring by three wheels which run in a groove. This allows the trolley plate to be affixed to a stationary point on the vehicle's suspension so that as the vehicle wheel turns the trolley plate remains stationary. A brush holder is provided which has a carbon brush which is spring-loaded with pressure against the slip ring and allows for intimate electrical contact between the vehicle electrical system which is connected in a non-moving stationary environment where 12 volts are provided to the brush. The brush makes contact with the slip ring so that as the wheel rotates there is a full-time electrical connection to the wheel. A cold rolled steel ferrous flag is bent at a right angle so that an intersection is made with the Hall Effect sensor. As the wheel rotates the flag passes through the jaws of the Hall Effect sensor. This allows wheel speed and top dead center location to be registered. All of the intelligent electronics rotate with the wheel feeding the microprocessor of the CPU which is also rotating with the wheel, the CPU having been bolted onto the overcap.

The wheel system works as follows.

A master PC board houses the CPU as well as an RF communication modem. The master PC board communicates with an arbitrary amount of slave boards (for example, 3 slave boards in one exemplary embodiment). The slave boards are controlled by the master board and have on-board intelligence to allow distribution of display addressing information from the master board to selectively illuminate the LEDs. Two exemplary embodiment sizes of slave boards can accommodate three different sizes of wheels, e.g., 22″, 24″ and 26″ diameter wheel. A long slave board has 32 LEDs and the short slave board has 24 LEDs. The LEDs are tri-color LEDs having red, blue and green LED elements. As such, 96 color elements are addressed when using a long slave board and 72 elements are addressed when using a short slave board.

Power is provided to the electronics by means of a slip ring assembly mounted on the inner face of the vehicle wheel. A slip ring track is affixed to the wheel so that it rotates with the wheel.

A trolley plate assembly has a trolley plate which is captive to an undercut groove, or track, in the slip ring track by means of three bearing mounted wheels which enable the trolley assembly to remain stationary in terms of rotation relative to the track as the track rotates with the wheel. The trolley plate mounts the brush assembly, which is a carbon composite brush spring-loaded to rest or ride against the brass slip ring which is imbedded or captive in, the trolley track such that a stationary point is provided for connecting power and sensing components. The carbon brush is in a brush holder which allows the carbon brush to be forced by a spring outward to maintain intimate contact with the slip ring as it rotates. A dog-bone portion of the brush holder holds strain relief or length change loops to accommodate for brush wear. The brass ring in the track is connected to the vehicle electrical system. A 12 volt path is provided from the vehicle electrical system. An electrical installation kit may include utilities having the ability to switch the path on and off, such as via the ignition key, and having each wheel individually fused. The 12 volts are provided by wire into the brush holder so that the voltage can be applied to the slip ring. Inside of the slip ring another wire carries the 12 volts onto the master board from which it is distributed to the electronics. A three conductor cable is coupled to a Hall Effect sensor, which is a magnetic sensing device which is used to monitor wheel rotational speed as well as wheel position. The Hall Effect sensor operates by being affixed to the track component which contains the slip ring. The ferrous flag which is affixed to the trolley plate so that they are in different inertial frames of reference, such that when the trolley plate is stationary the ferrous flag will be stationary, and as the wheel rotates the Hall Effect sensor, which is mounted to the track assembly which is rigidly affixed to the wheel, will periodically (once per revolution) intersect the ferrous flag. That is, the ferrous flag will pass through the jaws of the Hall Effect sensor. The passing through triggers the Hall Effect sensor and enables the Hall Effect sensor to tell the microprocessor not only that the wheel has passed this point once, but it is a known point, not necessarily top dead center, but whatever point it is on the orbit of rotation, it's going to be at that same point every single time. Software is built into the control program which enables the installer upon setting up the wheels to initialize a reference point for a top dead center reference so that when the wheels start rotating for the first time and an image appears (whether, for example, upside down or sideways) the reference point can be controlled for each wheel to provide the reference point to be at top dead center. The 12 Volts and the position and speed sensing data for deriving the wheel speed are provided to the master board. The actual speed is not important, but rather, how long it takes to make one revolution. The ground is provided by the actual vehicle hub. The power wiring running from a distribution block contains +12 volts and ground. The ground is connected to a stationary chassis as proximal to the wheel hub as possible. Because the hub is actually grounded, an unpainted unfinished pad surface portion of the wheel center making intimate contact with the wheel hub is utilized for ground.

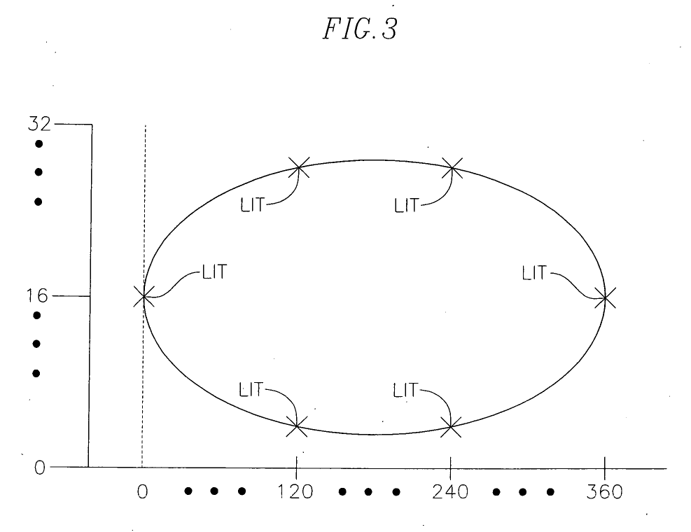

Referring to FIG. 3, an image (for example, graphics, text, or digital photo, as schematically depicted by an oval in FIG. 3), loaded by application software (described below), is converted into a matrix comprised of 32 vertical lines of resolution and 360 horizontal lines of resolution for a 32 LED display. The image around the wheel is made by functionally multiplexing a small number of LEDs into a large number of LEDs, exploiting the human cognitive phenomenon of persistence of vision and flicker fusion, similar to that underlying motion pictures. The matrix can be pictured by unwinding the image around the wheel. If it is imagined that the wheel never rotated and there were 360 slave boards (e.g., 360 strips of LEDs), the wheel could remain static and the same image could be displayed. The matrix comprises 360 columns which are 32 lights high. Starting at top dead center as position 0, and when one slave board is a 0, the matrix is interrogated and the information contained in column 0 of the matrix and strobe it to appropriate elements of the LED on the slave board desired to be illuminated. For each of the 32 positions there are 3 color elements of the LED being addressed.

The matrix is interrogated to determine what should be in column 0. In the example, there would only be one LED lit, namely the tangent point of the circle. Concurrently, since there are 3 slave boards displaced radially by 120°, the matrix is interrogated for 0°, for 120° and for 240°. At 120° there would be two portions of the circle's LEDs displayed, and at 240° there would similarly be two portions of the circle's LEDs displayed. This displays the snapshot in time. However, a time base, or time constant, is needed against which the matrix is interrogated and the slave boards are strobed with the appropriate columnar information. To establish the time base, the last two readings of the Hall Effect sensor are looked at to determine how long it took for the wheel to complete one revolution the last time and the duration of the previous revolution is used to calculate the time base for the subsequent revolution based on the assumption that, while the speed/duration of contiguous revolutions may vary, the percentage of variation from one to the next will be small, so it is therefore reasonable to utilize the time base derived from the rotation immediately proceeding the one for which the time constant calculations are presently being performed without fear of incurring a substantial error. This ‘hindsight’ method is employed because it is far more economical than any ‘real time’ speed/position sensing solution, though a ‘real time’ solution would certainly work. Given the last two hits of the Hall Effect sensor, for example, 360 milliseconds apart, the time interval is divided by the number of strobe events and determine that 360 milliseconds divided by 3600 means that every millisecond there must be an interrogation and strobing. Since 3 different positions are strobed, the image is reinforced 3 times per revolution. For 0° and millisecond 1, the information for column 0, column 120 and column 240 are strobed out. For 10 and millisecond 2, the information for column 1, column 121 and column 241 are strobed out. This is repeated for the entire 360°. When 120° is traveled, there will be an override of whatever previously done for 120° and the image is reinforced. The override will occur 3 times per revolution. The more slave boards there are, the less flicker will occur in the image, since the weight of override will be higher.

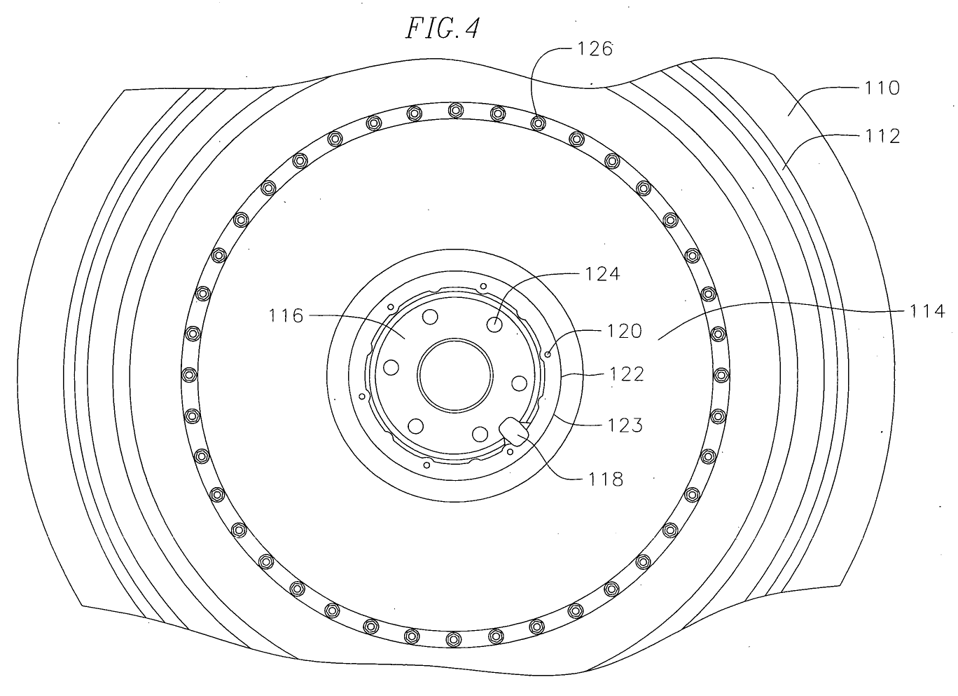

Referring now to FIG. 4, the inward face of the vehicle wheel is shown. Tire 110 is mounted to rim 112. Wheel center 114 includes pad 116. Rectangular pass-through hole 118 permits wiring and its connector from the slip ring assembly which is mounted on the back face of the wheel to pass through to the front face of the wheel where it plugs into the circuitry on the overcap. Six radially symmetrically places holes 120 are through holes which permit the mounting of the slip ring assembly to the wheel from the outside surface of the wheel. The reason that the trolley assembly is mounted in a removable fashion is to permit tire mounting as well as wheel balancing with the assembly components safely out of the way and not to throw off dynamic balance since with the large components designed not to rotate with the wheel, it would be very difficult to balance the wheel with those components in place. Ridge step 122 is cut into the interface of the wheel center to insure concentricity of the track assembly when it is bolted in place. Six large holes 124 provide for the lugs for mounting the wheel to the vehicle hub. The pad surface of the wheel center is unpainted, uncoated so that it remains electrically conductive to provide electrical ground. Circumferential distribution of nuts and bolts 126 attach the wheel center to the rim and may have six locations selectively omitted to provide for longer hardware to secure the overcap having the display electronics to the outside face of the wheel.

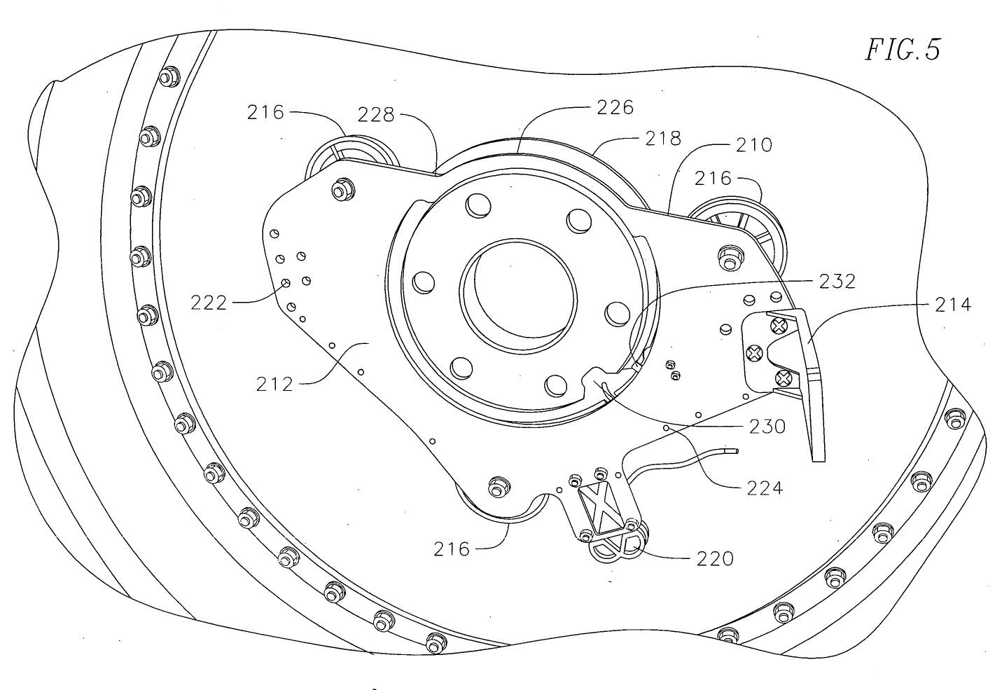

Referring now to FIG. 5, the inside back face of the vehicle wheel with the slip ring assembly with trolley assembly mounted is shown. Trolley assembly 210 includes aluminum trolley plate 212 which in turn includes angle bracket 214 which provides a means of securing the trolley plate to a stationary point on the vehicle suspension to prevent it from rotating when the wheel rotates. The angle bracket 214 protrudes some distance of the plane of the trolley plate to allow some reach suspension or brake components. Three trolley wheels 216 ride in a groove in a surface of the vertical face of the trolley track and are captive in a groove 218 in the trolley track. The three trolley wheels 216 are located about a circle and keep the trolley plate captive on the track assembly and permit the trolley plate to remain stationary while the track assembly rotates.

Brush holder 220 contains the carbon brush which is in intimate contact with the brass slip ring in the track assembly and allows for the transfer of the positive voltage from the vehicle electrical system, which is stationary, through to the rotating components of the wheel for power and display.

Hole distribution 222 provides options for the installer to install angle bracket 214 to provide access to varieties of the stationary objects of the vehicle. Hole distribution 224 provides the installer a place to secure any wiring which run to the plate to avoid the wiring getting caught up with anything rotating. There is a bilateral symmetry about cutout section 228 which allows mounting on the right or left side of the vehicle. Thin bridge section 226 provides clearance for brake calipers, since brake calipers sometimes protrude outward beyond the plane of the wheel pad and therefore would interfere with the trolley plate if it did not have cutout section 228. Machined clearance area 230 of the pad section of the wheel center accommodates the radially inward protrusion from the track assembly which supports the Hall Effect sensor. Ferrous flag 232 intersects the throat of the Hall Effect sensor on each rotation to indicate that the wheel has passed.

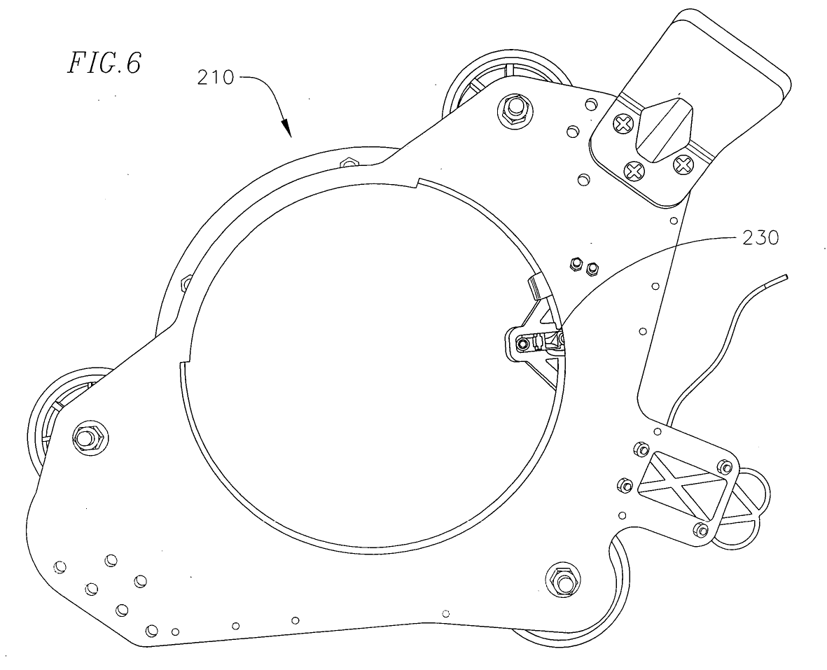

Referring now to FIG. 6, trolley assembly 210 is shown not mounted on the wheel with Hall Effect sensor 230 and its support structure more prominently displayed.

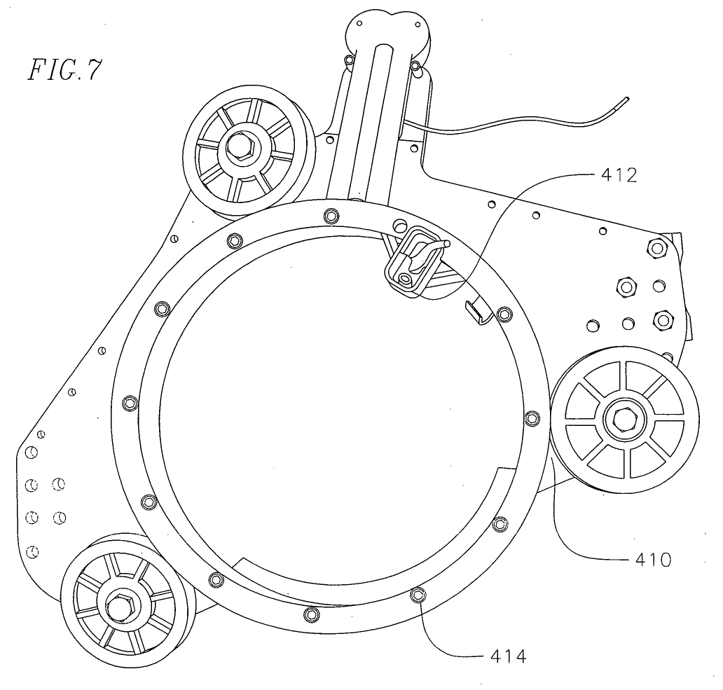

Referring now to FIG. 7, the opposite side of trolley assembly 210 of FIG. 6 is shown, particularly pointing out tangent point 410 with the groove lip capturing the wheel within the groove. Skirt sleeve mounting bracket 412 is used to key or register the placement of the track assembly on the vehicle wheel in the milled rectangular clearance slot which is provided to permit the passage of the connector and wiring from the trolley assembly through the front surface of the wheel. Six of the twelve threaded fasteners 414 (every other one) are used to assemble the sandwich of the track assembly comprising a track upper, a track lower, and a slip ring, providing the groove that captures the wheels. The other six are used to mount the track assembly to the vehicle wheel through the clearance hole in the wheel center.

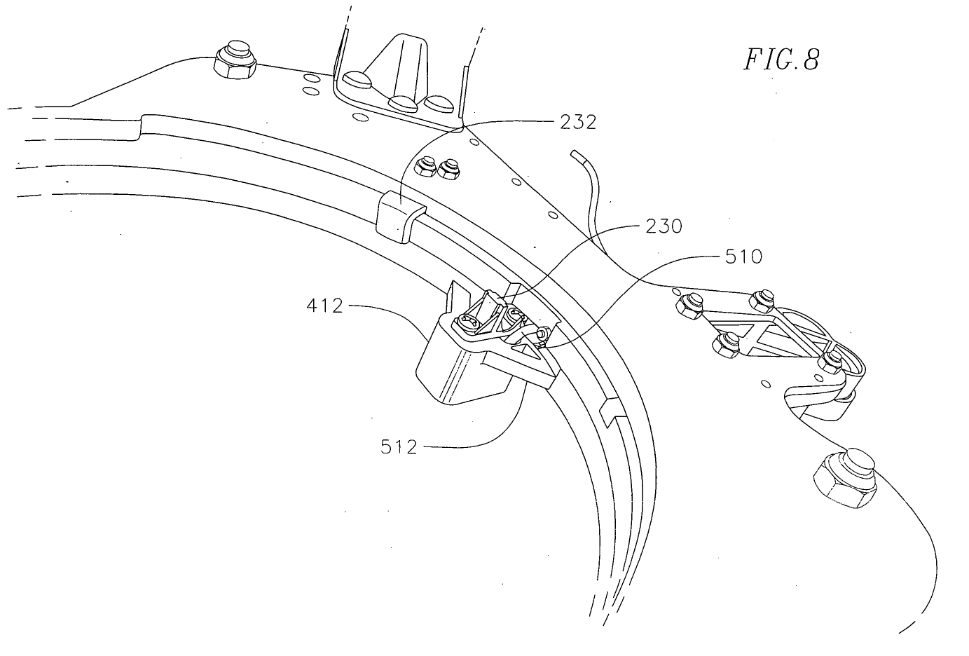

Referring now to FIG. 8, there is shown more clearly ferrous flag 232, Hall Effect sensor 230, and mounting bracket 412. The +12 volt wire 510 comes from the inside diameter of the slip ring. Mounting platform 512 mounts the Hall Effect sensor.

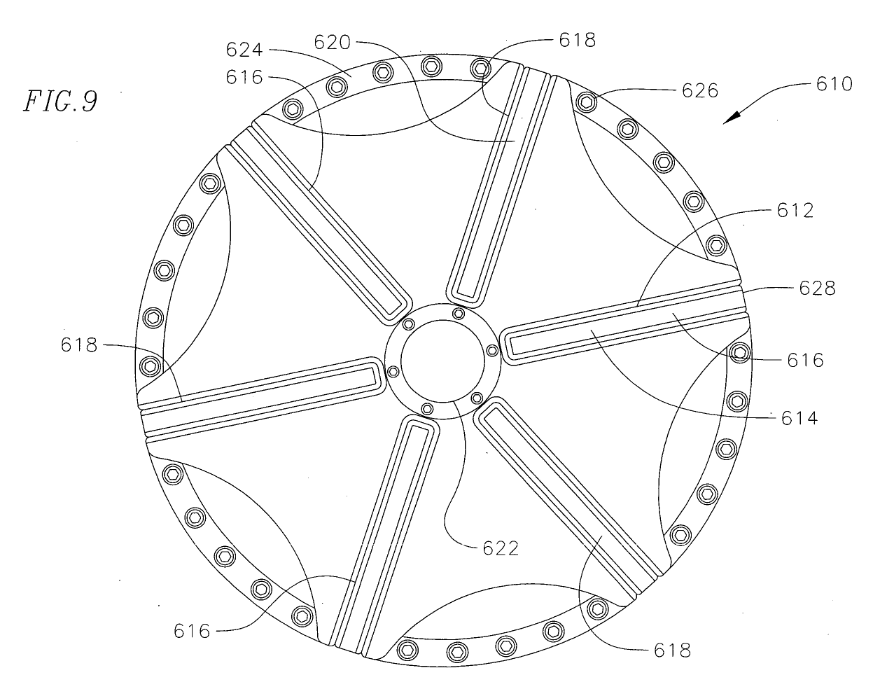

Referring now to FIG. 9, the outward facing side of overcap 610 is shown. Overcap 610 is the hubcap like component which bolts to the wheel and is both the cosmetic cover for the wheel as well as the housing for all of the electronics and the display emissive elements. Six through slots 612 are filled with a black tinted translucent LED cover 614. Three of the covers are dummy regions 616 for the purpose of radial symmetry. Three of the covers are active regions 618 occupied by slave boards and the emissive elements thereof. The translucent tinting camouflages the fact that three of the regions are dummies and three of the regions are active light emitters. Through the tinting the active areas 618 show the tri-color LEDs 620. Center cap 622 is merely decorative. Mounting ring 624 is also decorated with dummy rivet heads 626. Six locations 628 allow for the securing of the overcap to the wheel assembly by bolts.

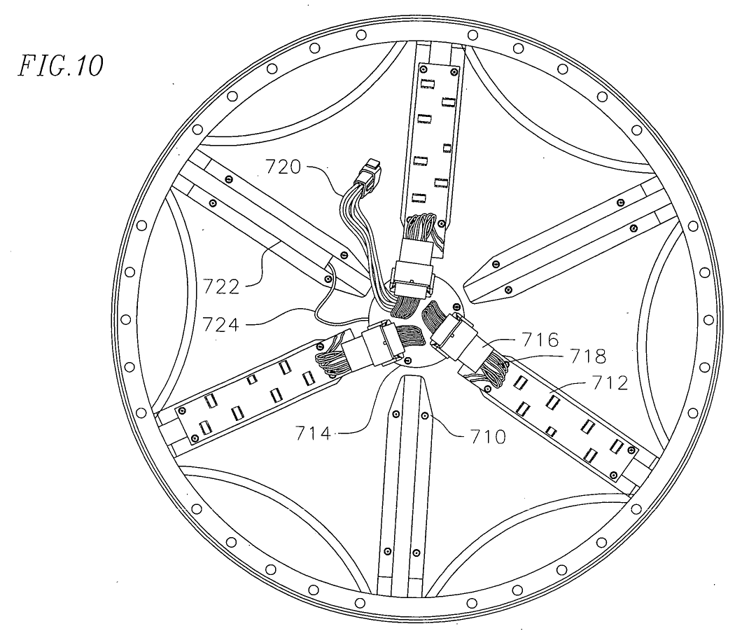

Referring now to FIG. 10, there is shown the inward facing side of the overcap shown in FIG. 9.

The tinted LED covers are secured with fasteners 710 to the inside of the overcap. Slave boards 712 are mounted in this embodiment at three of the LED cover regions and master board 714 is mounted at the center region. Waterproof connectors 716 are located in the midpoint of the wire harnesses and facilitate defective component replacement. Wire harness and connector 720 connect (not shown) the electronics to the power and signals provided by the slip ring assembly. RF antenna 722 and RF antenna cable 724 are connected to the RF modem (not shown) which is mounted on the reverse side of the master board.

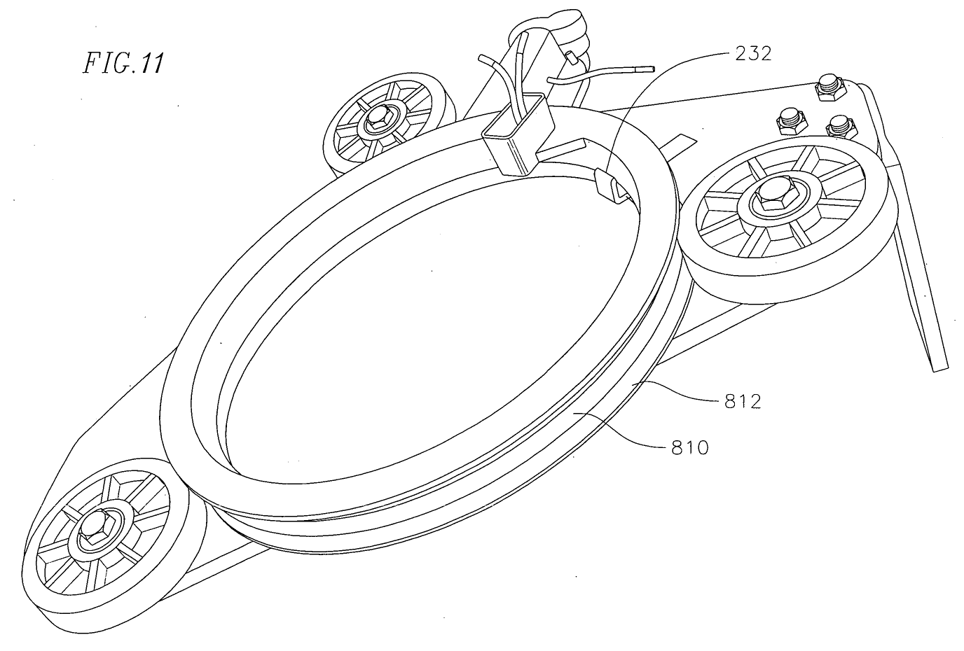

Referring now to FIG. 11, there is shown another view of the trolley assembly showing ferrous flag 232, slip ring 810 and groove edges 812 of the slip ring groove within which the wheels are captured.

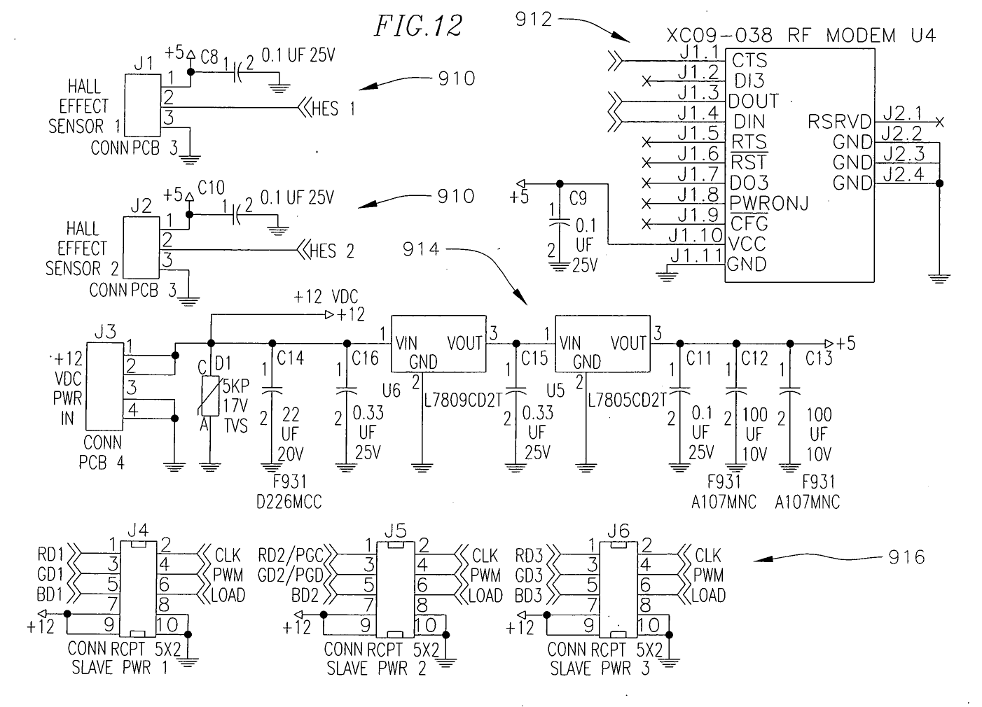

Turning now to the electrical and electronics circuitry, FIG. 12 shows Hall Effect sensor circuit 910, RF modem circuit 912, power distribution circuit 914 and slave power distribution circuits 916. In the exemplary embodiment described above, there is one Hall Effect sensor. However, in another exemplary embodiment depicted by circuit 910 there are two Hall Effect sensors, one of which is dedicated to indicating top dead center, while the other is dedicated to measuring in real time the wheel speed by clocking between multiple ferrous flags. RF modem 912 circuit provides bidirectional communication between the modem on each wheel and the modem of a desktop or laptop computer to program. The bidirectional communication allows for acknowledgement and parity checking. The RF modem allows the loading of the display information generated, in real time while the vehicle is in motion, from the wireless laptop computer up to 6 frames to each wheel independently while driving.

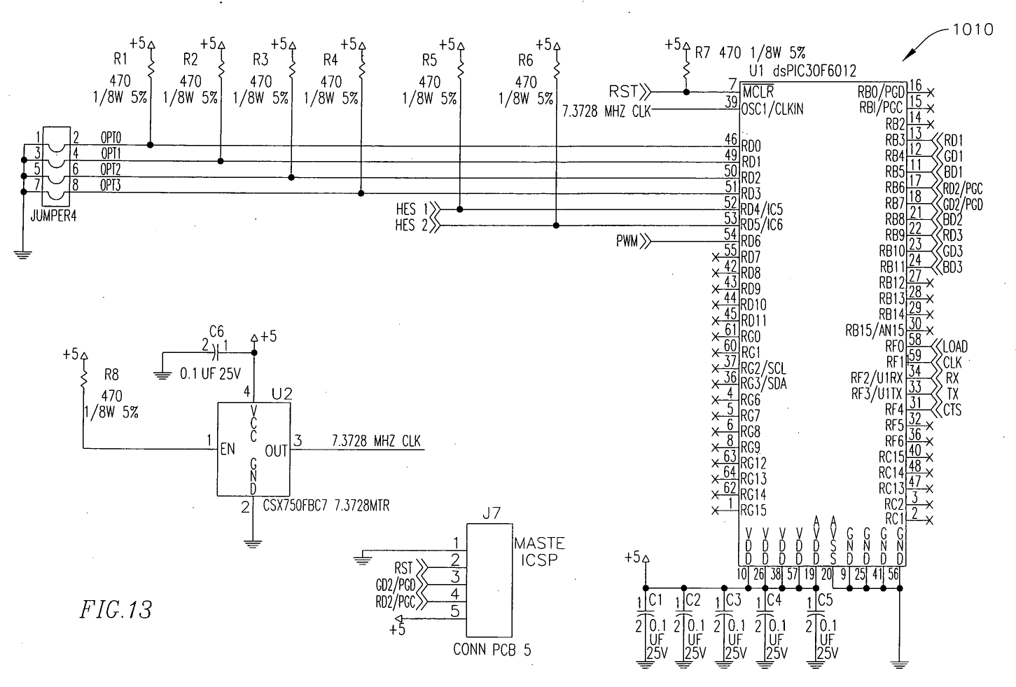

FIG. 13 shows CPU circuitry 1010 which provides input/output and power connections to the microprocessor which processes the various signaling, power distribution, timing and communication functions. Operating system software of the microprocessor processes how images coming in as a matrix that was created at the user interface is distributed to the LEDs with regard to the various environmental inputs, such as wheel speed and position.

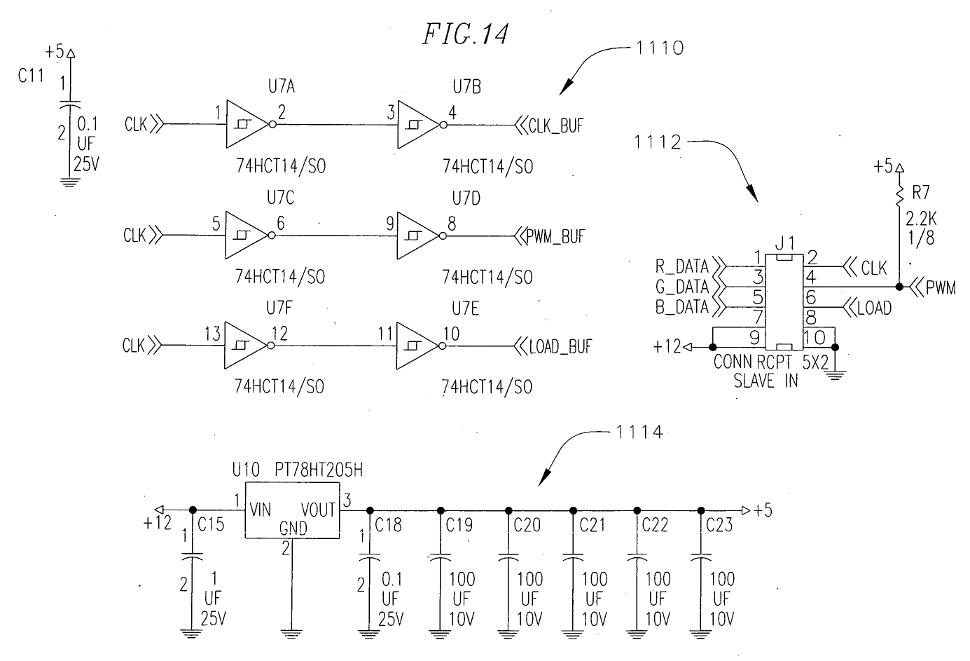

FIG. 14 shows slave board power and signal connection circuitry. Circuitry 1110 provides clock, pulse width modulation and load buffering. Circuitry 1112 provides pin connectors for data lines, clock, pulse width modulation and load lines, +12 voltage and ground. Circuitry 1114 provides the high current device voltage regulator used to drive all of the LEDs.

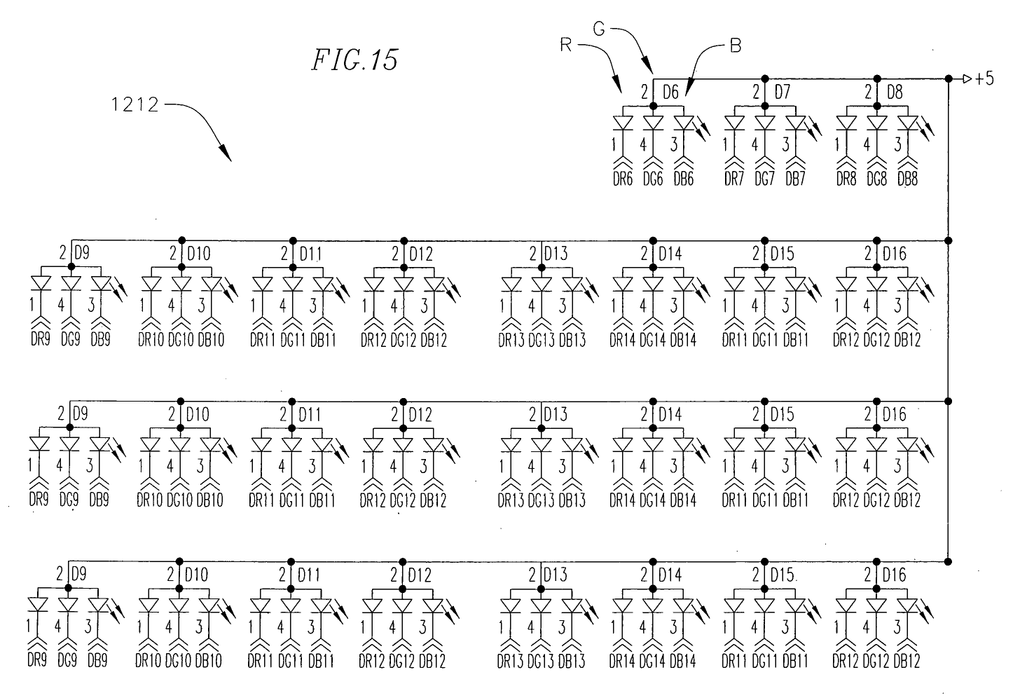

FIG. 15 shows LED chain circuitry 1212, depicting tri-color red, green and blue elements R, G, B of each the 32 tri-color LEDs.

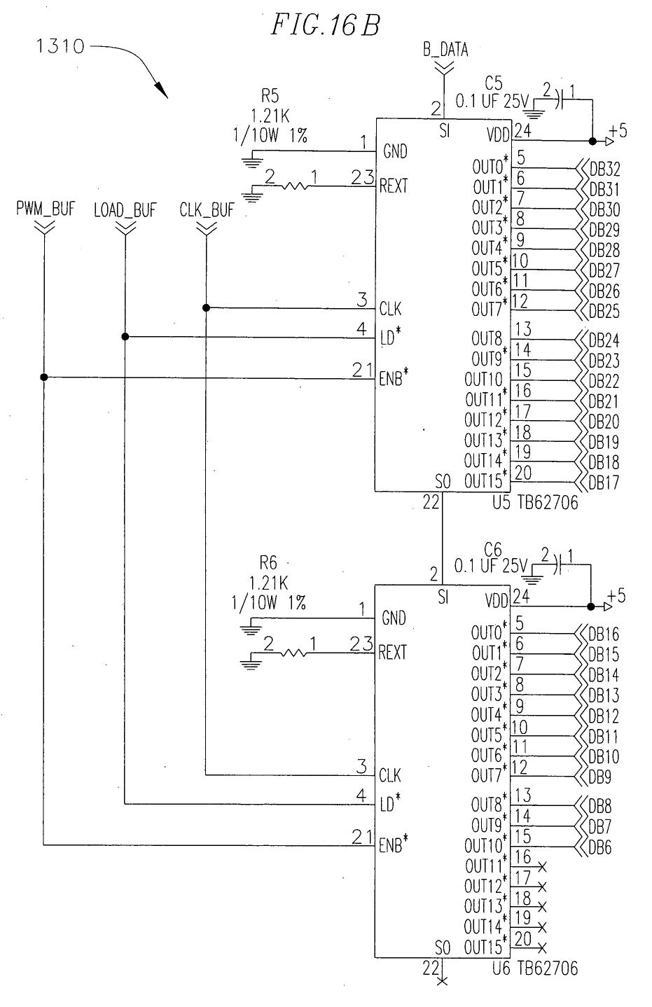

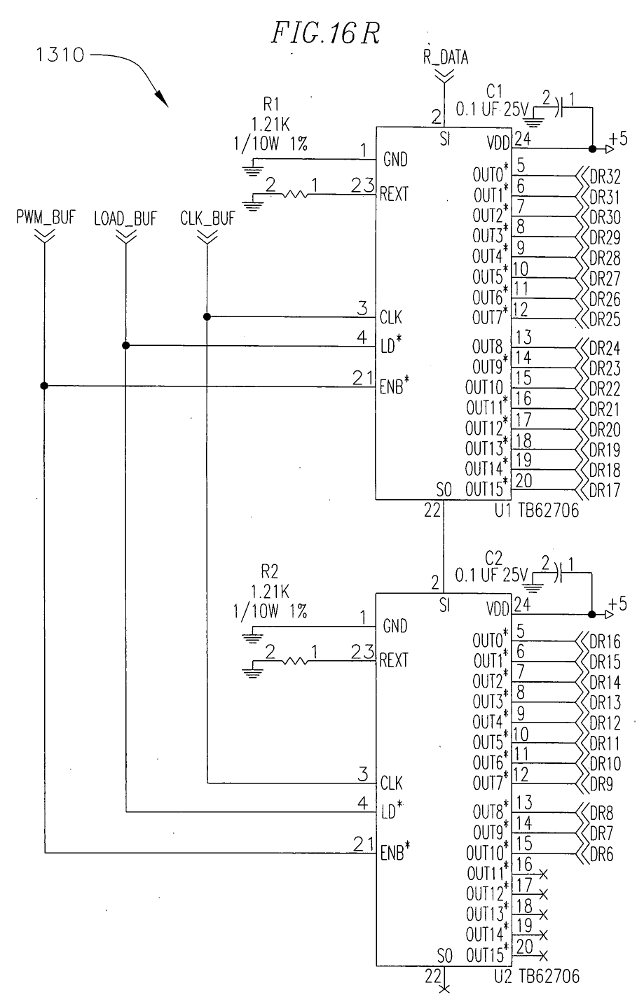

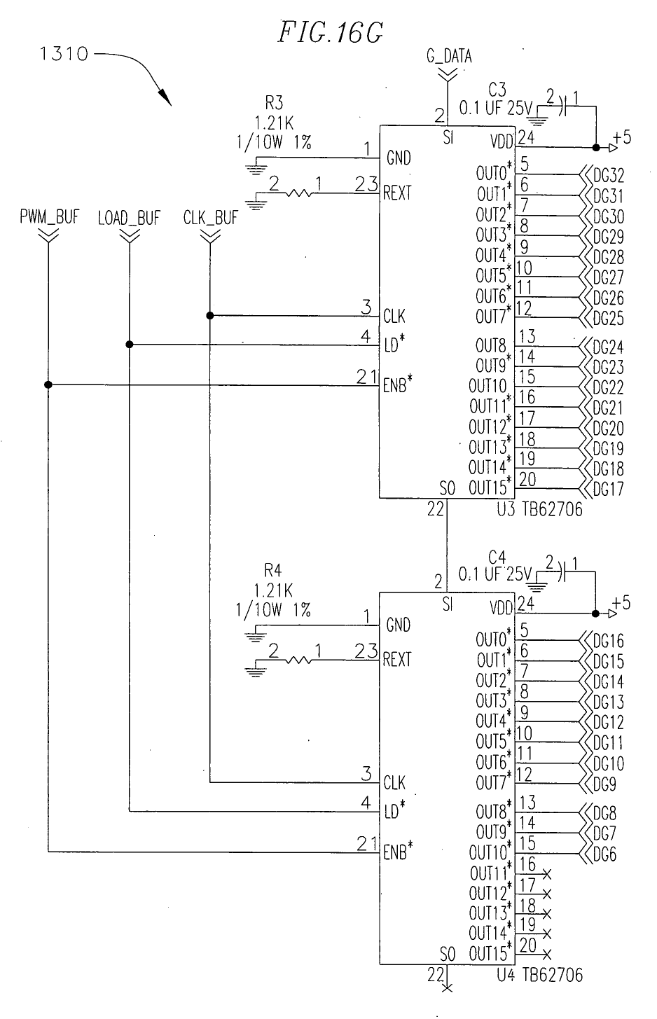

FIGS. 16B, 16R and 16G show shift register circuitry 1310 for the respective blue, green, and red LED emission. The shift registers provided sequencing of a serial data stream and distribution to the multiple LED diode devices.

Turning now to the application display software, there is provided a user interface. The application display software operates before the image is displayed on the wheel. Once the image is provided to the wheel, it is the resident operating software for the CPU which determines how the image is presented for display as described above for the matrix interrogation and strobing. The application display software allows a wrapped text to be written straight with respect to top dead center of a wheel rotation.

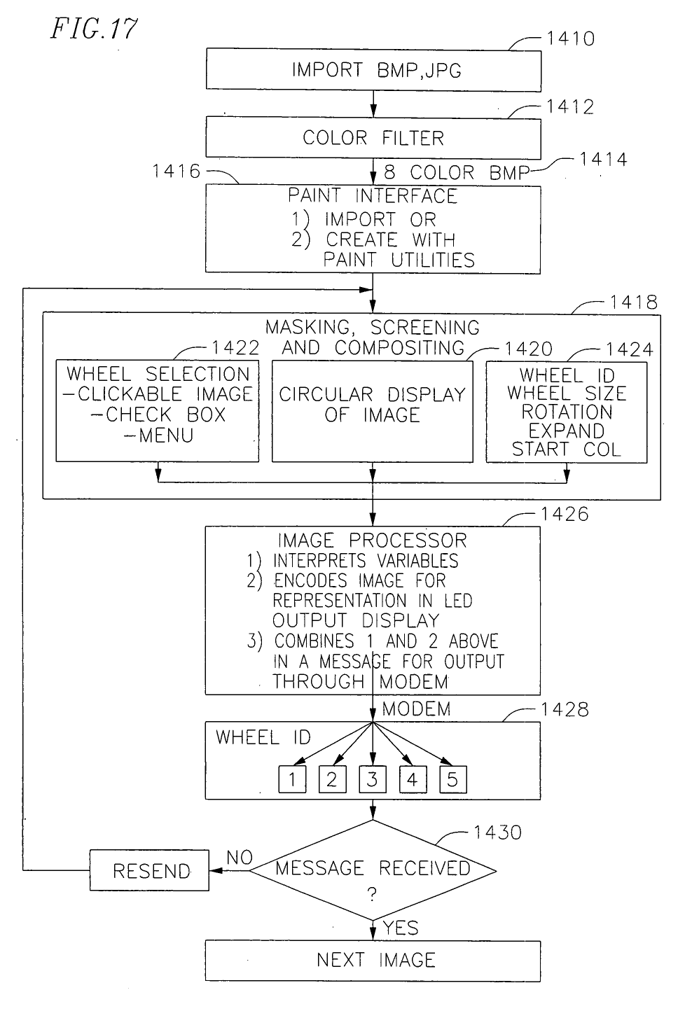

Referring to FIG. 17, there is shown a user interface software application flow chart in block diagram form. At block 1410, bit map or jpeg images are imported. At block 1412, the images pass through a color filter which is a converter that will convert multiple colors of the imported images into the 8 available colors 1414. At block 1416 which shows the paint interface, imported images or newly created images are manipulated. At block 1418 which shows the masking, screening and compositing, block 1420 converts the image for a circular display. Block 1422 provides wheel selection which provides the ability to click and drag an image to load it onto a given or selected wheel, and has a menu where variables can be selected, such as dwell time an image resides on the display before it changes over to a next image. Block 1424 provides setup items, such a unique wheel ID for security purposes to avoid unauthorized communication with the vehicle wheel, wheel size selection for image compression, such as for 24 or 32 LEDs, rotation and expansion of image visual features, and a start column initialization of the position of the image rotationally based upon the completely random and arbitrary initial mechanical installation of the Hall Effect sensor, such that the software provides the top dead center as plumb level and upright. In block 1426, the image processing occurs wherein input variables are interpreted, encoded for representation in the LED output display, and combined the interpretation and encoding to create and output the matrix with some compression through the modem. The communication from modem in the computer to the modem on the wheel is a slightly compressed and parity bit safeguarded matrix. The communication is sent out serially for each of the wheels as shown in block 1428, depicting five possible wheels, which include the standard vehicle front and rear wheels along with a fifth wheel, presently not used but could be a rotating device such as a spinner in the vehicle front grill. At block 1430, parity and confirmation messaging is provided along with providing for a next image processing.

In other exemplary embodiments, rather than using a slip ring assembly, battery power may be provided or power may be generated internally. As such, the power supply may be in a self-contained hubcap. Position and speed sensing could be done by a pendulum or a device similar to hub odometers using on large over the road trucks where a unit is mounted with bearings to the center of the wheel and is heavily counterweighted so it remains stationary while the wheel spins inside of it. An embodiment using the pendulum may, in addition to determining position and speed, be the stator portion of a generator and use the rotational motion of the wheel and the stationary position of the pendulum to build a generator to produce the electrical power needed. In another embodiment, rather than mounting the overcap to the wheel, the overcap may be a spinner such that the hubcap is centrally pivoted on bearings such that even when the vehicle is not in motion, the spinner remains in motion, allowing the display of multiplexed information while the wheel is stationary.

In accordance with the present invention an exemplary installation procedure for the wheels are now described in more detail

The vehicle is first raised off the ground, being supported securely. All four wheels are removed. If a lift is available, the job becomes much easier.

The hood is raised and the battery (or a +12VDC power bus tied directly to the battery), the fuse block (or an ignition switched +12VDC wire or power source), and a suitable mounting location for the power block are located.

A suitable mounting location for the power block is located. Ideally this location is close to the battery, the ignition switched power, a chassis ground, and away from any extreme heat sources (e.g., the exhaust), solvents, water, or debris. The power block is not mounted at this time, but is kept in the mounting location to determine wire lengths and proper routing.

A chassis ground is first identified. This is usually any point connected to the chassis or metal body panels. A fastener is located which is a ground point and which may be removed or loosened to accept a ring terminal.

A heavy power cable is plugged into the power block. A suitable ground point is located and two ground wires are secured to the chassis ground. Next, a positive wire is routed to the positive terminal of the battery, or any suitable +12VDC bus. The positive wire is cut to length, striped for crimping a ring terminal, but not attached to the battery at this time.

Next, the three conductor cables from the power block are routed through the firewall into the passenger compartment. This cable goes to a rocker switch which is used to turn the electrical power to the wheels on and off from inside the vehicle. A suitable location is identified for the switch. A bracket is mounted and the cable is run to this location. When passing through the firewall, an existing grommeted wire pass-through is typically used rather than drilling a hole. The green wire in the three conductor cable (at the power block end) is connected to an ignition switched +12VDC source. It is typically easiest to use a fuse tap for connection at the fuse block in an appropriate circuit.

The four power and ground conductor cables are plugged into the power block and each cable is routed to the four wheels of the vehicle. These are the wires which carry power and ground to each wheel and they are routed such that they are protected from. heat, road hazards, and moving components. All wires are secured with cable ties.

The ground wire is attached to a solid ground point as close to each wheel's hub or spindle as practicable. Generally, some non-critical fastener (such as a mounting bracket bolt) is found which may be loosened to accommodate the ground wire. termination. Hardware relating to the vehicle's brake system or suspension is never loosened, removed, or attached to. The power wire will be connected to the electronics when the wheels are mounted. An insulated spade connector is crimped onto the power wire, then secured out of the way until it is time to mount the wheels.

Finally, the ring terminal on the heavy gauge power wire is connected to the battery. A supplied relay is plugged into the power block. Fuses are inserted into the power block as well. The power block is mounted using cable ties. Any removed panels or covers to access the battery, fuses, etc. are then replaced.

The electrical system can then be tested to make sure the wiring has been completed correctly. To test, the vehicle's ignition is turned to ‘on’ without starting the engine. The rocker switch is flipped to the ‘on’ position (it should illuminate) and a test light or multi-meter may be used to verify that +12VDC is present at each wheel's power wire (spade connector) and that the ground wires are properly grounded. The switch is then flipped to ‘off’ and the vehicle ignition is turned off. The wheels are now ready to be mounted.

The wheels may be shipped with slip ring assemblies mounted to protect them from damage in transit. These slip ring assemblies are removed before mounting or balancing tires. The slip ring assembly is held onto the wheel center by means of machine screws which can be accessed through countersunk holes on the front of the wheel center. These fasteners are removed and the slip ring assembly is carefully taken out of the wheel. The location of the rectangular ‘key’ which registers in the hole in the wheel center through which the wiring connector passes is to be noted. Tires are mounted and balanced. The slip ring assemblies are replaced, hand tightening the mounting hardware.

The wheels are held in position on the hub of the vehicle. The location and orientation of the trolley plate is visually inspected, particularly as it relates to the brake caliper, to insure that there is clearance between the trolley plate and the caliper. One section of the trolley plate has been relieved to provide clearance for the caliper. The trolley plate is to be aligned so that the caliper resides in this area. In some vehicle applications, the caliper does not protrude into the area occupied by the trolley plate, so trolley plate orientation is not critical.

Once the proper orientation for the trolley plate has been identified, the right angle bracket is test fitted and a suitable anchor point on the vehicle's suspension is identified. A suitable anchor point is one which moves up and down with the suspension, does not rotate with the wheel, is not part of or connected to the brakes, and which is within reach of the mounting bracket.

Once a suitable location has been identified, the angle bracket is mounted to the trolley plate using bolts and nylock nuts.

Lug nuts are now installed and tightened, securing the wheels to the vehicle. A double check is made to be sure that the trolley plate and all components remain free and are not pinched by or trapped behind any vehicle components, especially the brake caliper.

The angle bracket is now secured to the anchor point identified earlier. Threaded fasteners, cable ties, plumber's tape, fabricated brackets, or the like may be used with the following caveats: 1.) it is critical that no pre-load be placed on the angle bracket. This means that, twisting, bending, torquing, or in any way biasing the position of the bracket away from the position where it naturally falls must be avoided. If a pre-load stress is placed on the bracket, it may cause the trolley wheels to machine themselves to destruction against the trolley track or other components. This will drastically reduce the life of the wheel components. 2.) whatever means is used to secure the angle bracket to the anchor point must be both secure and easily detached because the angle bracket will need to be separated from the anchor point whenever the wheel is removed from the vehicle. This means that if there is a flat tire, the angle bracket will need to be able to be detached to permit removal of the wheel in order to put on a spare tire. Use of a clevis pin or some other positively located, yet easily removed without tools, fastener is recommended.

A mating insulated spade connector to the power wire attached to the trolley plate is stripped and crimped. This wire is plugged into the connector on the power wire run earlier from the power block.

The overcaps are now set up. The circuit board in the center of each overcap contains a tiny set of switches which is used to configure each overcap to its position on the vehicle. The following may be used to properly set the switches for each wheel position: Right Front, Left Front, Right Rear, Left Rear.

The overcaps are mounted to the wheels. First, the connector from the circuit board inside the overcap is plugged into the mating connector hanging through the wheel center. The mounting holes in the overcap are aligned with the missing bolts in the wheel center, and secured with the nuts and bolts.

Connections may be again tested by turning on the vehicle ignition (making sure the engine is not started), flipping the switch to ‘on’ and observing each overcap. The LEDs should illuminate and cycle through stationary patterns of alternating colors and chaser lights. The wheels are now ready to be programmed.

The software application programs, which come on a CD ROM, are first installed on a user computer. The modem CD is first inserted into the computer's CD drive and onscreen install instructions are followed. Next, the wheel CD is installed. The modem is plugged into a USB port on your computer.

The first step in programming the wheels is to set ‘top dead center’ so that the images will be upright on the wheels. In order to do this, the wheels must be spinning. If the vehicle is on a lift, and if it can be done safely, it may be possible to start the engine and put the vehicle in gear and allow the wheels to spin so the programming may be performed without actually driving the vehicle. If this approach is used and the vehicle is all wheel drive, it may be possible to program all four wheels in this manner. If no lift is available, or if it is not safe to operate the drive train while the vehicle is on the lift, or if the vehicle is only two wheel drive, a suitable alternative method is to use two vehicles, where the exemplary embodiment wheel equipped vehicle drives slowly in a straight line in a safe area such as a large parking lot, and another vehicle drives along side, with a portable computer, such that programming may be accomplished while both vehicles are in motion. Speeds no faster than 15 to 20 mph are used during this operation, and all caution is exercised to prevent a collision. If this approach is used, the drivers of both vehicles are responsible only for the safe operation of the vehicles and a passenger must perform all programming and observation tasks.

In order to establish ‘top dead center’ for a wheel, an image is first sent to the wheel which has a clear and easily perceived orientation. It may be desirable to send a word such as ‘TEST’ or a series of characters so the proper orientation is easy to see. This task is performed on one wheel at a time. Once the image is displayed, it will very likely not be properly oriented. A ‘wheel setup’ portion of the wheel program is accessed, the wheel in question is highlighted and either the slide control or entry of numeric values between 0 and 360 is used to rotate the image to the proper position. This is done for all of the wheels and values are saved. These values may be written down for safekeeping, although once set, this will never have to be done again unless a wheel is replaced.

Now, in accordance with the present invention, an exemplary embodiment of the application software functionality will now be described in more detail. The application software may be a Visual Basic application that runs on a laptop computer or PDA. Its purpose is to provide an operator friendly interface for the user to create an image for display on the wheels. Each wheel is comprised of a matrix of pixels which may be 32 rows high by 360 columns wide, and wrapped around the wheel to create a complete circle. Other embodiments may include a matrix having 24 rows high by 360 columns wide.

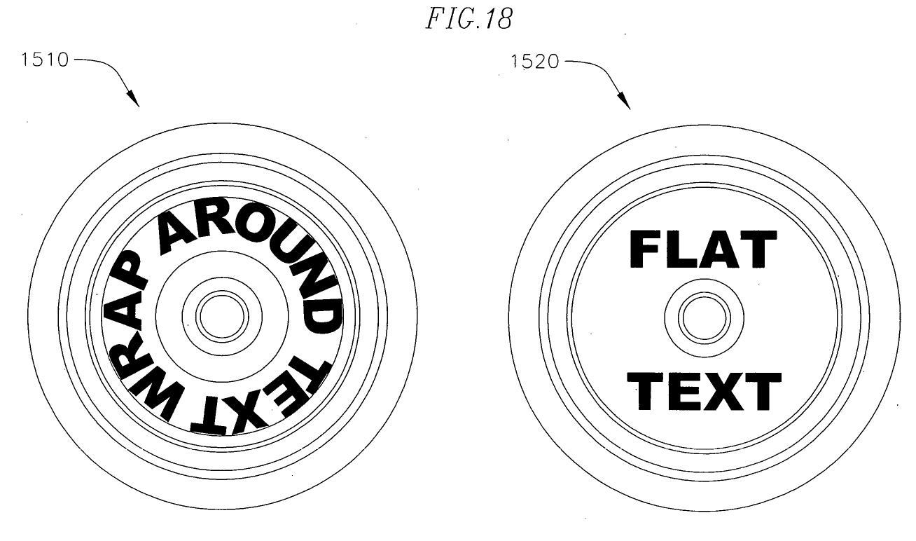

The application software may be configured to operate in a manner similar to Microsoft's Paint program. Using tools similar to those in Paint, the user is be able to type text, import an image, or freehand draw to fill each pixel with one of 8 colors: Black (OFF), Red, Green, Blue, Yellow, Pink, Aqua or White. The user would have the ability to select text attributes such as point size, font style, color, and orientation (e.g., center top, center bottom—to wrap the text symmetrically around the wheel, or offsets to position the text at any point around the wheel). When importing JPEG images, it becomes necessary for the user to be able to zoom in or out, crop, shift center point, and retouch. Obviously, the application may reduce image resolution to the 32 by 360 limit of the matrix. Finally, as shown in FIG. 18, the user may have the option of ‘wrapping’ the image 1510 around the wheel, or displaying it straight across 1520 (as though it was a circular cut out of a conventional ‘flat printed’ image).

The user may create kaleidoscopic patterns, solid colors, or random patterns. The program may preview exactly how the image will appear on a wheel, and send this information, or “image” (the complete display matrix for one image) to the wheel when the user presses the ‘send to wheel’ button. The specified image(s) may then be down loaded via RS232 or USB ports to an RF device which will wirelessly broadcast it to the wheel(s).

The user has the ability to send a given “image” to one specific wheel, several wheels, or all four wheels.

The program has a number of ‘stock’ images or patterns which may be selected, or a ‘stock’ “script” (sequence of images) which may be selected as a default. The program permits the user to store a number of favorite or frequently used images which may be readily called up and sent to the wheel(s).

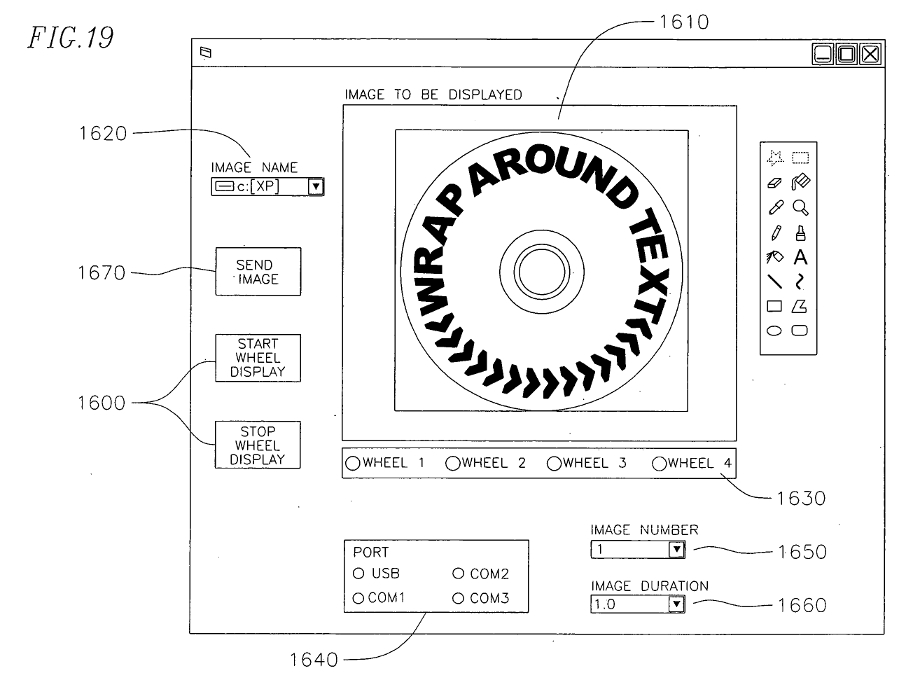

FIG. 19 depicts an exemplary embodiment of the wheel application software user interface. Operational start and stop keys 1600 are provided. 1) Light wheel image 1610 displays the file selected by the Image Name box 1620. If no file is selected then a default pattern of 360 columns is displayed in a circular fashion. Each column will be 32 pixels high. 2) The user has the ability to select R Front, R Rear, L Front or L Rear in any combination. This will determine which of the wheels 1630 will receive the image. 3) The user can select any of four PORTs 1640 (this may be in a setup page, not part of the application): USB, COM1, COM2, COM3. The COM ports will default to 8 data bits, 1 stop, no parity, with a baud rate of 3 8.4K. 4) The user will select the Image Number 1650. The Light Wheel can currently accept up to 7 images. 5) The user will select the Image Duration 1660. This will determine how long the image will be displayed. The units are in seconds and tenths of seconds. 6)The Send Image button 1670 will send a message out the selected port in a data format described below.

One image will be equal to 8656 bytes. Each column of data has three colors-Red, Green and Blue. The column is 32-bits high or 4 bytes. To describe one column requires 12-bytes. The most significant bit will be the outer most ring around the wheel, the least significant bit will be the inner most ring.

Four process steps- include: 1) SEND IMAGE TO SELECTED WHEEL(S), 2) START DISPLAY, 3) STOP DISPLAY, and 4) INIT ID.

The four process steps will now be described in more detail below.

### 1) Send Image to Selected Wheel(s)

When the Send Image button is pressed a message will be sent to the selected port in the following manner:

### Data Specification:

One frame will be equal to 8656 bytes. Each column of data has three colors—Red, Green and Blue. The column is 32-bits high or 4 bytes. So to describe one column will require 12-bytes. The most significant bit will be the outer most ring around the wheel, the least significant bit will be the inner most ring.

When the Send Frame button is pressed a message will be sent to the selected port in the following manner:

| BYTE# | CONTENT | HEX | REMARKS |
|---|---|---|---|
| 0 | STX | 0x02 | Start of Text |
| 1 | ‘0’ . . . ‘9’ | 0x30 . . . 0x39 | ID, Numbers ‘0’ through ‘9’ - |
| | | | 100K |
| 2 | ‘0’ . . . ‘9’ | 0x30 . . . 0x39 | ID, Numbers ‘0’ through ‘9’ - |
| | | | 10K |
| 3 | ‘0’ . . . ‘9’ | 0x30 . . . 0x39 | ID, Numbers ‘0’ through ‘9’ - |
| | | | 1K |
| 4 | ‘0’ . . . ‘9’ | 0x30 . . . 0x39 | ID, Numbers ‘0’ through ‘9’ - |
| | | | Hundreds |
| 5 | ‘0’ . . . ‘9’ | 0x30 . . . 0x39 | ID, Numbers ‘0’ through ‘9’ - |
| | | | Tens |
| 6 | ‘0’ . . . ‘9’ | 0x30 . . . 0x39 | ID, Numbers ‘0’ through ‘9’ - |
| | | | Ones |
| 7 | ‘F’ | 0x46 | Message Type - SEND FRAME |
| 8 | Wheel # | 0x30 . . . 0x34 | Wheel Number. 0 = All Wheels |
| 9 | Frame # | 0x30 . . . 0x39 | Frame Number - Tens Digit 0–9 |
| 10 | Frame # | 0x30 . . . 0x39 | Frame Number - Ones Digit 0–9 |
| 11 | Frame Time | 0x30 . . . 0x39 | Frame Duration - Tens Digit 0–9 |
| 12 | Frame Time | 0x30 . . . 0x39 | Frame Duration - Ones |
| | | | Digit 0–9 |
| 13 | Frame Time | 0x30 . . . 0x30 | Frame Duration - Tenths |
| | | | Digit 0–9 |
| 14 | Spare | 0x30 | Spare Byte = 0 |
| 15 | Spare | 0x30 | Spare Byte = 0 |

The following is the DATA section of the message. Each Column has three colors—Red, Green & Blue. Each color is 32-bits long or 4-bytes. The outer most LED of the wheel is the most significant bit (bit 31) and the inner most is the least significant bit (bit 0). A byte of data will be broken into two hexadecimal numbers and sent. For example if the user want to set column 0 to the following binary red pattern: 0001 0010 0100 1000 1100 1101 1111 0000, he would encode it as follows:

| Byte # | ASCII | CHAR |
|---|---|---|
| 16 | 0x31 | ‘1’ |
| 17 | 0x32 | ‘2’ |
| 18 | 0x34 | ‘4’ |
| 19 | 0x38 | ‘8’ |
| 20 | 0x43 | ‘C’ |
| 21 | 0x44 | ‘D’ |
| 22 | 0x46 | ‘F’ |
| 23 | 0x30 | ‘0’ |

| | | |
|---|---|---|
| 16–23 | Data - Col 0, Red | Column 0 - Red Data |
| 24–31 | Data - Col 0, Grn | Column 0 - Green Data |
| 32–39 | Data - Col 0, Blu | Column 0 - Blu Data |
| 40–47 | Data - Col 1, Red | Column 1 - Red Data |
| 48–55 | Data - Col 1, Grn | Column 1 - Green Data |
| 56–63 | Data - Col 1, Blu | Column 1 - Blu Data |
| ″ | ″ | ″ |
| ″ | ″ | ″ |
| ″ | ″ | ″ |
| 8632–8639 | Data - Col 359, Red | Column 359 - Red Data |
| 8640–8647 | Data - Col 359, Grn | Column 359 - Green Data |
| 8648–8655 | Data - Col 359, Blu | Column 359 - Blu Data |
| 8656 | ETX 0x30 | End of Text |

### 2) Start Display

### When the Start Display button is pressed, the previously stored message(s) will be display on the selected wheel(s).

| BYTE | | | |
|---|---|---|---|
| # | CONTENT | HEX | REMARKS |
| 0 | STX | 0x02 | Start of Text |
| 1 | ‘0’ . . . ‘9’ | 0x30 . . . 0x39 | ID, Numbers ‘0’ through ‘9’ - |
| | | | 100K |
| 2 | ‘0’ . . . ‘9’ | 0x30 . . . 0x39 | ID, Numbers ‘0’ through ‘9’ - |
| | | | 10K |
| 3 | ‘0’ . . . ‘9’ | 0x30 . . . 0x39 | ID, Numbers ‘0’ through ‘9’ - |
| | | | 1K |
| 4 | ‘0’ . . . ‘9’ | 0x30 . . . 0x39 | ID, Numbers ‘0’ through ‘9’ - |
| | | | Hundreds |
| 5 | ‘0’ . . . ‘9’ | 0x30 . . . 0x39 | ID, Numbers ‘0’ through ‘9’ - |
| | | | Tens |
| 6 | ‘0’ . . . ‘9’ | 0x30 . . . 0x39 | ID, Numbers ‘0’ through ‘9’ - |
| | | | Ones |
| 7 | ‘S’ | 0x53 | Message Type - START |
| | | | DISPLAY |
| 8 | Wheel # | 0x30 . . . 0x34 | Wheel Number. 0 = All Wheels |
| 9 | ETX | 0x03 | End of Text |

### 3) Stop Display

### When the Stop Display button is pressed, the current image(s) will stop being display on the selected wheel(s).

| BYTE | | | |
|---|---|---|---|
| # | CONTEXT | HEX | REMARKS |
| 0 | STX | 0x02 | Start of Text |
| 1 | ‘0’ . . . ‘9’ | 0x30 . . . 0x39 | ID, Numbers ‘0’ through ‘9’ - |
| | | | 100K |
| 2 | ‘0’ . . . ‘9’ | 0x30 . . . 0x39 | ID, Numbers ‘0’ through ‘9’ - |
| | | | 10K |
| 3 | ‘0’ . . . ‘9’ | 0x30 . . . 0x39 | ID, Numbers ‘0’ through ‘9’ - |
| | | | 1K |
| 4 | ‘0’ . . . ‘9’ | 0x30 . . . 0x39 | ID, Numbers ‘0’ through ‘9’ - |
| | | | Hundreds |
| 5 | ‘0’ . . . ‘9’ | 0x30 . . . 0x39 | ID, Numbers ‘0’ through ‘9’ - |
| | | | Tens |
| 6 | ‘0’ . . . ‘9’ | 0x30 . . . 0x39 | ID, Numbers ‘0’ through ‘9’ - |
| | | | Ones |
| 7 | ‘E’ | 0x45 | Message Type - STOP |
| | | | DISPLAY |
| 8 | Wheel # | 0x30 . . . 0x34 | Wheel Number. 0 = All Wheels |
| 9 | ETX | 0x03 | End of Text |

### 4) Init ID

When the Init ID button is pressed, the selected 6 digit ID number will be sent.

| BYTE # | CONTEXT | HEX | REMARKS |
|---|---|---|---|
| 0 | STX | 0x02 | Start of Text |
| 1 | ‘0’ . . . ‘9’ | 0x30 . . . 0x39 | ID, Numbers ‘0’ through ‘9’ - 100K |
| 2 | ‘0’ . . . ‘9’ | 0x30 . . . 0x39 | ID, Numbers ‘0’ through ‘9’ - 10K |
| 3 | ‘0’ . . . ‘9’ | 0x30 . . . 0x39 | ID, Numbers ‘0’ through ‘9’ - 1K |
| 4 | ‘0’ . . . ‘9’ | 0x30 . . . 0x39 | ID, Numbers ‘0’ through ‘9’ - Hundreds |
| 5 | ‘0’ . . . ‘9’ | 0x30 . . . 0x39 | ID, Numbers ‘0’ through ‘9’ - Tens |
| 6 | ‘0’ . . . ‘9’ | 0x30 . . . 0x39 | ID, Numbers ‘0’ through ‘9’ - Ones |
| 7 | ‘I’ | 0x49 | Message Type - INIT ID |
| 8 | Wheel # | 0x30 . . . 0x34 | Wheel Number. 0 = All Wheels |
| 9 | ‘0’ . . . ‘9’ | 0x30 . . . 0x39 | New ID, Numbers ‘0’ through ‘9’ - 100K |
| 10 | ‘0’ . . . ‘9’ | 0x30 . . . 0x39 | New ID, Numbers ‘0’ through ‘9’ - 10K |
| 11 | ‘0’ . . . ‘9’ | 0x30 . . . 0x39 | New ID, Numbers ‘0’ through ‘9’ - 1K |
| 12 | ‘0’ . . . ‘9’ | 0x30 . . . 0x39 | New ID, Numbers ‘0’ through ‘9’ - Hundreds |
| 13 | ‘0’ . . . ‘9’ | 0x30 . . . 0x39 | New ID, Numbers ‘0’ through ‘9’ - Tens |
| 14 | ‘0’ . . . ‘9’ | 0x30 . . . 0x39 | New ID, Numbers ‘0’ through ‘9’ - Ones |
| 15 | ETX | 0x03 | End of Text |

While this invention has been described in connection with what is considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method of displaying an image on a rotatable wheel, the rotatable wheel being mountable on a hub rotatable relative to a fixed chassis, the method comprising:
mounting a computer processing system on an inward face of an overcap mountable on the rotatable wheel;
mounting light emitters on an outward face of the overcap, the light emitters being responsive to light emission signals from the computer central processing system;
axially mounting a slip ring assembly on an inward face of the rotatable wheel, the slip ring assembly being adapted to provide electrical power to the computer processing system;
fixedly mounting a trolley assembly to the chassis such that the trolley assembly is axially aligned with the slip ring assembly, the trolley assembly being adapted to couple the electrical power to the slip ring assembly; and
providing displayable image signals to the computer processing system, the computer processing system being adapted to transmit the light emission signals corresponding to the image to the light emitters.

2. The method of claim 1, wherein providing displayable image signals to the computer processing system includes sending the displayable image signals to the computer processing system by wireless communication from a remote terminal.

3. The method of claim 1, wherein:
the trolley assembly includes a sensor flag fixedly mounted on the trolley assembly;
the slip ring assembly includes a sensor mounted on the slip ring assembly, the sensor detecting sensor flag presence as the sensor flag passes the sensor as the rotatable wheel rotates to provide wheel rotational speed information to the computer processing system; and
the light emission signals are synchronizingly transmitted by the computer processing system to the light emitters to provide a fixed image corresponding to the wheel rotational speed information.

4. The method of claim 1, wherein the trolley assembly includes a brush holder housing a spring-loaded carbon brush making electrical contact with a slip ring of the slip ring assembly, the slip ring being electrically coupled to the computer processing system, the spring-loaded carbon brush receiving electrical power from a remote power source and providing electrical power to the slip ring.

5. The method of claim 1, wherein the light emitters are one or more light emitting diode assemblies, each light emitting diode assembly including a series of light emitting diodes radially mounted.

6. The method of claim 3, wherein providing displayable image signals to the computer processing system includes:
converting the image into a series of pixels arranged in a matrix, a column height of the matrix corresponding to a number of light emitters arranged radially in series on the overcap, a row length of the matrix corresponding to a radial-to-linear parsing value of the image; and
synchronizing the wheel rotational speed information with the matrix to provide light emitter timing information to the computer processing system.

7. The method of claim 3, wherein the sensor is a Hall Effect sensor.

8. The method of claim 1, wherein the rotatable wheel is an automotive wheel.

9. An image displaying wheel assembly, comprising:
a rotatable wheel, the rotatable wheel being mountable on a hub rotatable relative to a fixed chassis;
an overcap mountable on the rotatable wheel,
a computer processing system mounted on an inward face of the overcap;
light emitters mounted on an outward face of the overcap, the light emitters being responsive to light emission signals from the computer central processing system;
a slip ring assembly axially mounted on an inward face of the rotatable wheel, the slip ring assembly being adapted to provide electrical power to the computer processing system;
a trolley assembly fixably mountable to the fixed chassis such that the trolley assembly is axially aligned with the slip ring assembly, the trolley assembly being adapted to couple the electrical power to the slip ring assembly; and
a displayable image signal processor electrically coupled to the computer processing system,
wherein the displayable image signal processor provides to the computer processing system displayable image signals corresponding to a displayable image and the computer processing system transmits to the light emitters the light emission signals in response to the displayable image signals.

10. The image displaying wheel assembly of claim 9, wherein the displayable image processor includes a wireless transmitter, the computer processing includes a wireless receiver and the displayable image signals are provided to the computer processing system by wireless communication.

11. The image displaying wheel assembly of claim 9, wherein:
the trolley assembly includes a sensor flag fixedly mounted on the trolley assembly;
the slip ring assembly includes a sensor mounted on the slip ring assembly, the sensor detecting sensor flag presence as the sensor flag passes the sensor as the rotatable wheel rotates to provide wheel rotational speed information to the computer processing system; and
the light emission signals are synchronizingly transmitted by the computer processing system to the light emitters to provide a fixed image corresponding to the wheel rotational speed information.

12. The image displaying wheel assembly of claim 9, wherein the trolley assembly includes a brush holder housing a spring-loaded carbon brush making electrical contact with a slip ring of the slip ring assembly, the slip ring being electrically coupled to the computer processing system, the spring-loaded carbon brush receiving electrical power from a remote power source and providing electrical power to the slip ring.

13. The image displaying wheel assembly of claim 9, wherein the light emitters are one or more light emitting diode assemblies, each light emitting diode assembly including a series of light emitting diodes radially mounted.

14. The image displaying wheel assembly of claim 11, wherein the sensor is a Hall Effect sensor.

15. The image displaying wheel assembly of claim 9, wherein the rotatable wheel is a automotive wheel.
